(19) United States
(12) Patent Application Publication
(10) Pub. No.: US 2008/0003938 A1
(43) Pub. Date: Jan. 3, 2008

(54) Method for Regulating Air Nozzles for Air-Conditioning a Motor Vehicle

(75) Inventors: Wilhelm Baruschke, Wangen (DE); Dieter Heinle, Pludershausen (DE); Dietrich Klingler, Heubach (DE); Karl Lochmahr, Vaihingen/Enz (DE); Eric Pitz, Stuttgart (DE); Klaus Voigt, Bietigheim-Bissingen (DE)

Correspondence Address: FOLEY AND LARDNER LLP;SUITE 500, 3000 K STREET NW, WASHINGTON, DC, 20007, US

(73) Assignee: BEHR GmbH & CO. KG

(21) Appl. No.: 10/585,728

(22) PCT Filed: Jan. 14, 2005
(86) PCT No.: PCT/EP05/00351

§ 371 Date: Aug. 23, 2007

(30) Foreign Application Priority Data
Jan. 15, 2004 (DE) 10 2004 002 364.6
Jun. 1, 2004 (DE) 10 2004 026 912.2

(51) Int. Cl. B60H 1/34; F25D 17/08

(52) U.S. Cl. 454/143; 62/186

(57) ABSTRACT

The invention relates to a method for regulating an air nozzle (3) for air-conditioning a motor vehicle. An actuator which is used to control a ventilation device and/or an actuator which is used to control the width of the air jet and/or an actuator which is used to control the direction of air and/or a heating device are associated with said air nozzle (3). At least one sensor, which is used to receive measuring values, is provided. The adjustment of the air nozzle (3) is regulated according to measuring values of the sensor.

The invention relates to a method of adjusting air vents for air-conditioning a motor vehicle according to the precharacterizing clause of claim 1.

Conventionally, the air vents are set by hand, even during a journey, whereby, if the driver wishes to make adjustments to one or more air vents, he/she is distracted at least momentarily.

An automated heating and/or air-conditioning system for vehicles, with automatically adjustable air vents, is known from DE 100 46 628 A1. In said patent, horizontal and vertical slats are provided for adjusting direction and air flow valves are provided for adjusting air volume, wherein the slats and the air flow valves are motor-driven. A vent control panel is provided for this purpose, on which at least one control element is arranged with which a preset standard program for adjusting the slats and air flow valves may be set. Such an arrangement still leaves something to be desired.

It is the object of the invention to provide an improved method of adjusting air vents.

This object is achieved by a method having the features of claim 1. Advantageous developments constitute the subject matter of the subordinate claims.

According to the invention, a method is provided for adjusting or controlling an air vent for air-conditioning a motor vehicle. Assigned to the air vent are actuators for controlling air direction (air outflow direction—up/down, left/right) and/or actuators for controlling air jet divergence between directed air outflow (“spot”) and diffuse air outflow (“diffuse”). Preferably, such air vents for selectively setting a directed air outflow (“spot”) and a diffuse air outflow (“diffuse”) take the form of swirl vents, with which both the diffuse outflow characteristic is achieved, by means of swirl imparted to the outflowing air, and directed outflow. Swirl is imparted for example by means of spirally arranged air guide elements, as disclosed in the German patent application bearing file ref. 10 2004 024 064.7, which is not a prior publication. Such vents, which may in particular be automatically controlled, are generally also known as “comfort vents”.

Also provided are a fan device for the air volume control means and/or a heating device for temperature control. To record measured values, at least one sensor, for example for temperature or air speed, is arranged in the air vent or externally. The measured values are used for automatic adjustment of the air vent. Automatic adjustment of the air vent(s), in particular the side and central vent(s) on the driver's side, makes it possible to achieve optimum comfort for the driver, without him/her having to perform manual adjustment of the air vents, so reducing the attention he/she pays to the traffic.

Automatic adjustment preferably changes air jet divergence between spot jet and diffuse outflow and/or the directional setting of the air vent (left/right, up/down) and/or the air volume which enters the vehicle cabin through the air vent, and/or the outflow velocity of the air emerging from the air vent, wherein adjustment takes place as a function of measured values, such as for example current cabin temperature, or indeed ambient or external temperature, which are detected by one or more sensors in the vehicle cabin.

In addition, automatic adjustment may preferably change the mixing ratio of warm and cold air which enters the vehicle cabin through the air vent, such that the temperature may be changed optimally and if necessary as quickly as possible. To this end, cold and warm air is preferably supplied separately to the air vent, adjusted by air valves or similar apparatus, mixed in the air vent and fed into the vehicle cabin.

The temperature of the air emerging into the vehicle cabin may also be changed by heating elements, e.g. PTC elements, or cooling means, for example Peltier elements, directly inside or just upstream of the air vent when necessary within a short reaction time, until an optionally necessary adaptation of the cooling or heating power of the air-conditioning system has taken place and air at the correct temperature reaches the air vent.

Automatic adjustment of the humidity of the air which enters the vehicle cabin through the air vent is also possible. In this case, in the event of a change in the ambient parameters, such as solar radiation, moisture may be removed from or optionally added to the air supplied to the vehicle cabin in the air vent. Preferably, the air vent is adjusted as a function of solar radiation, since, when the sun is low in the sky, one side of the vehicle cabin is heated up considerably, so impairing comfort, such that cooling is preferably increased automatically by changing the air vent settings in the affected area accordingly.

Preferably, automatic adjustment also includes the addition of a fragrance or scent to the air entering the vehicle cabin through the air vent. This and/or its concentration may be changed if one or more of the measured values detected by one or more sensors change(s).

To determine the parameters which are necessary for automatic adjustment of the air vents, preferably at least one sensor is provided for detecting the surface temperature of at least one body part of a vehicle occupant. With the assistance of such a sensor, an air jet may be oriented in such a way that the occupant is as comfortable as possible with optimum temperature distribution without feeling a draft.

Preferably, to optimize air vent adjustment, a plurality of sensors are provided which detect for example seat occupancy and/or seat position and/or the posture and/or size of the occupant. The ability to detect that a seat is not occupied makes it possible optionally to deactivate individual air vents or to use these air vents for air-conditioning of other climate zones. In addition, if the presence of a child seat is detected, appropriate adjustment of the air supply, preferably an alteration of the settings in the “diffuse” direction, may take place, such that the child or baby is protected from a draft. If the seat position is changed, preferably the vertical and lateral settings of the emerging air jet are automatically changed; however, air volume adjustment and a change to the “spot/diffuse” setting may also take place. The same also applies to posture.

A sensor preferably detects the status of one or more windows and/or of a sunroof and/or of a soft top, in order to control the air vent(s) accordingly, since for example an open side window also leads to a draft in the rear compartment, such that it is sensible to adapt the air supply. Optionally, a strong, upwardly directed air jet may also deflect the draft from the area of the rear seat, in particular if it is occupied by a baby or child seat; however this depends on the geometry of the vehicle cabin and other circumstances.

Preferably, individual or all the sensors are assigned to individual climate zones, such that optimum temperatures may be achieved in each climate zone by air vent adjustment.

To achieve optimum personalized settings, the program is preferably adaptive, i.e. it stores manual setting changes taking account of the other parameters when the default settings are changed, such that if the same or a similar situation occurs, a correspondingly modified automatic air vent adjustment is effected.

The present invention also provides an air-conditioning or heating system, which is provided with at least one air-conditioning controller, one or more air vents, at least one air vent having assigned to it a heating device and/or an air volume control means and/or an actuator for the air volume control means and/or a fan device and/or an actuator for controlling a fan device and/or an actuator for the air direction control means and/or an actuator for controlling air jet divergence, and at least one sensor for recording measured values. The air-conditioning controller has assigned to it a program for automatic adjustment of the air vent as a function of measured values and setting values. This program is in particular adaptive and may for example store and carry out recurring sequence instructions.

The invention is explained in detail below with reference to exemplary embodiments, sometimes with variants, and to the drawings, in which:

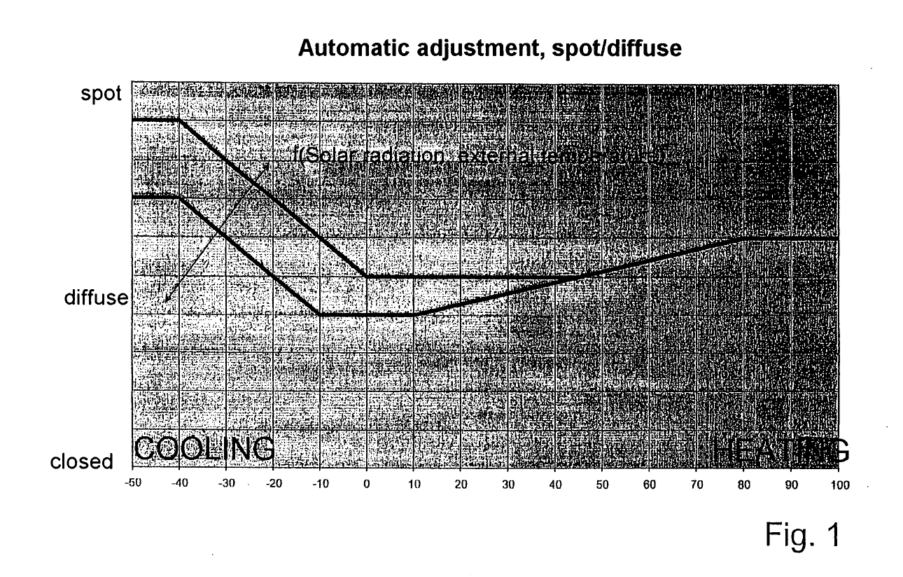

FIG. 1 is a function chart for automatic adjustment of the central vents with regard to the positions “spot” and “diffuse”,

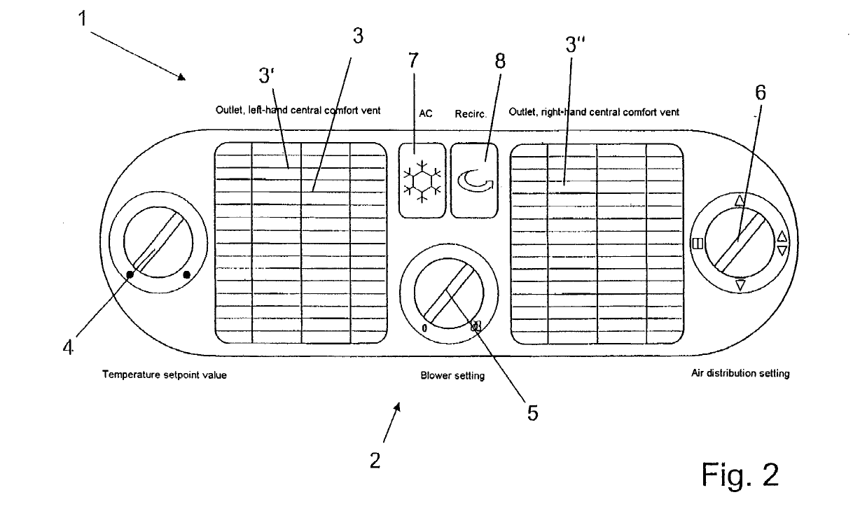

FIG. 2 shows a central vent arrangement according to the first exemplary embodiment,

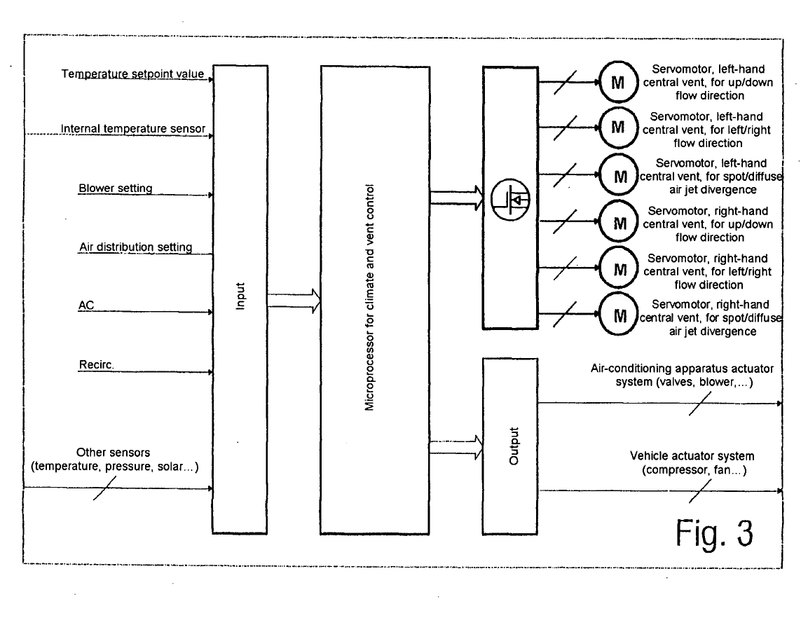

FIG. 3 is a representation of the modular structure of an air-conditioning controller according to one variant,

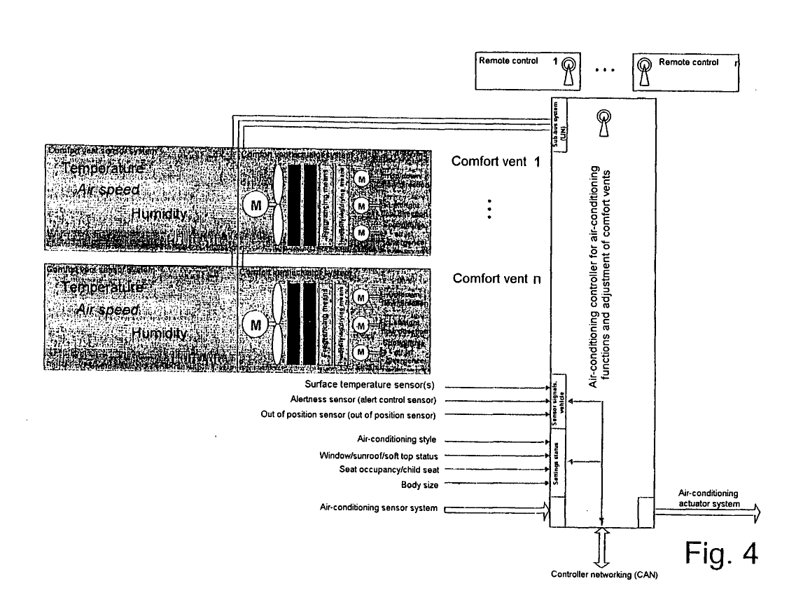

FIG. 4 is a block diagram for the adjustment of comfort air vents,

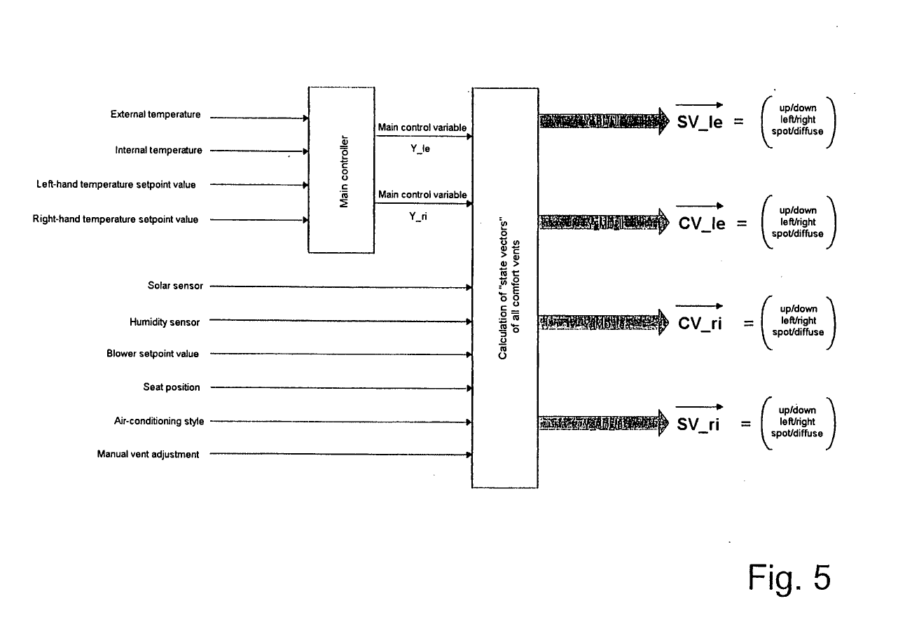

FIG. 5 is a block diagram relating to the system integration of comfort air vent adjustments,

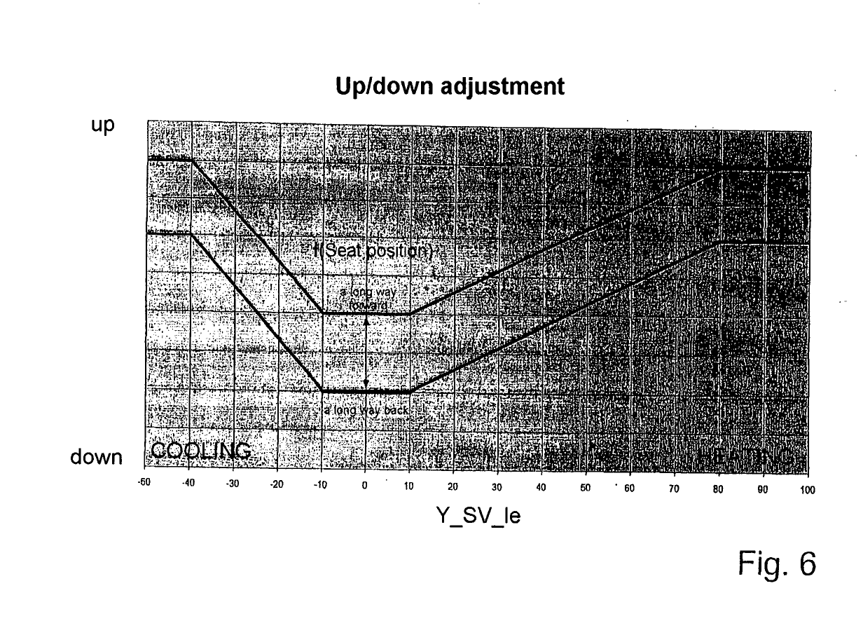

FIG. 6 is a function chart for adjusting the “up/down” flow direction of a left-hand side vent,

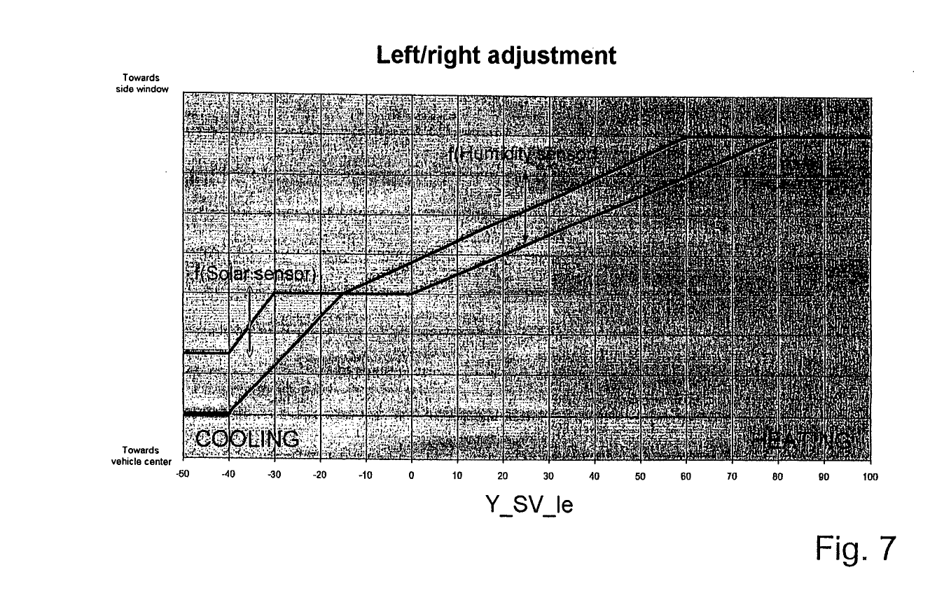

FIG. 7 is a function chart for adjusting the “left/right” flow direction of a left-hand side vent, and

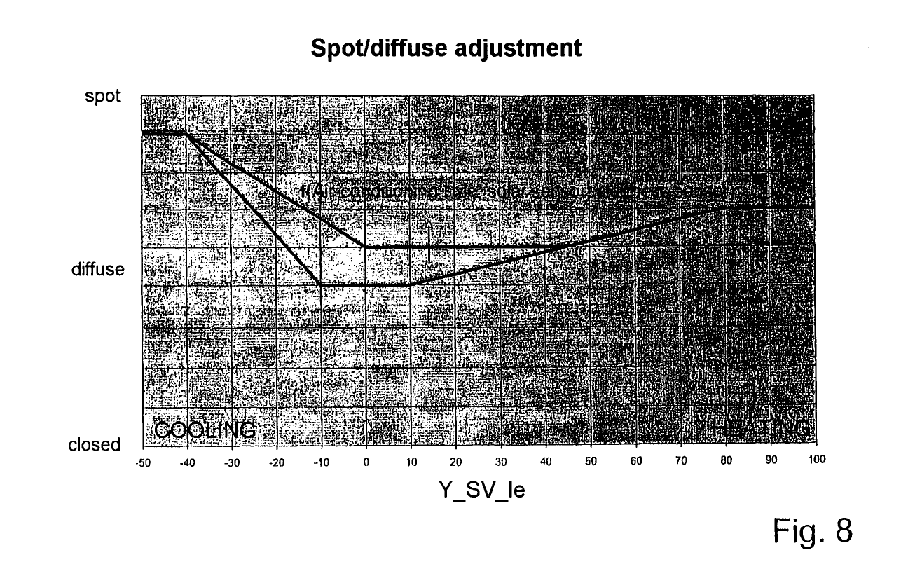

FIG. 8 is a function chart relating to air jet divergence between “spot” and “diffuse” for a left-hand side vent.

A motor vehicle air-conditioning system of basically conventional structure comprises a control unit 1 arranged in the motor vehicle center console, the air-conditioning control system being at least partially integrated therein. The control unit 1 is part of an assembly 2, which in the exemplary embodiment shown also comprises two central vents 3, wherein a central vent 3′ is assigned to the driver and a central vent 3″ is assigned to the front passenger. The control unit 1 comprises the known setting options for vehicle air-conditioning, in the present case a knob 4 for setting the setpoint temperature value, a knob 5 for setting blower output, a knob 6 for setting the air distribution of the air-conditioning system, a switch 7 for actuating the air-conditioning (AC) and a switch 8 for recirculation mode. As is clear from FIG. 1, the central vents 3 are incorporated into the same fascia, namely that of the assembly 2, as the knobs and switches 4 to 8. By configuring the assembly 2 with a control unit 1 and central vents 3, final assembly is considerably simplified, among other things.

FIG. 3 is a schematic representation of the modular structure of the air-conditioning controller according to one variant, with independent adjustment of the right- and left-hand central vent 3. The input, i.e. the input parameters, supplied to the climate control here includes the setpoint temperature value set via the knob 4, the cabin temperature detected by the internal temperature sensor, the blower output set via the knob 5, the air distribution set via the knob 6, activation or deactivation of the air-conditioning system via the switch 7, activation or deactivation of recirculation mode via the switch 8, and a plurality of other measured values from various sensors, such as in particular an external temperature sensor, a pressure sensor and a sensor for detecting solar radiation. The climate control assesses the input parameters and, in the case of changes, outputs signals to various elements of the air-conditioning system, such as valves or blowers, and of the vehicle, such as the compressor and fan, so as to change the settings if necessary. Climate control additionally involves setting the central vents 3, for which purpose the servomotor for the up/down flow direction and/or the servomotor for the left/right flow direction and/or the servomotor for spot/diffuse air jet divergence for the left- and/or right-hand central vent 3 is actuated as a function of the knob 6.

According to the first exemplary embodiment, only joint actuation of the right- and left-hand central vents 3 is provided, such that the servomotors left/right for the up/down flow direction and the left/right flow direction and the spot/diffuse air jet divergence in each case takes place corresponding to one another. Of course, a joint servomotor may in each case be provided for the right- and left-hand central vents 3, such that the number of servomotors is reduced by half from six to three.

In order to offer the driver/front passenger the greatest possible comfort, in the case of an appropriate default setting, automatic control of the spot/diffuse air jet divergence takes place as a function of the selected setpoint temperature, the solar radiation and the external temperature, as illustrated in FIG. 1. Thus, when the system is set to “cooling” and there is elevated solar radiation and/or an elevated external temperature, an automatic slight shift takes place from the position “diffuse” towards a spot jet. When the system is operated with minimal cooling or heating, automatic air jet divergence into a diffuse jet takes place, which, in the case of heating, adopts an intermediate state between the spot and diffuse positions.

According to a further variant not shown in the drawings, the side vents are similarly constructed, i.e. the control unit is arranged in the vicinity of the side vents instead of the central vents.

According to a further variant, control of the side vents is effected in accordance with that of the central vents in the event of corresponding adjustment.

As a consequence of the automatic detection of a change in parameters, according to the first exemplary embodiment and its variants in particular in solar radiation, automatic adjustment of the air vent takes place, preferably with previous appropriate programming or setting to “automatic vent control”, with regard to jet divergence, such that the driver does not have to perform any adjustment process or activate an adjustment process at the particular time, so meaning that he/she is not distracted and the most pleasant vent setting (resulting from empirical values) is automatically achieved. However, manual adjustment is not ruled out.

According to one variant, manual, optionally also personalized, changes are stored and are included in determining the optimum comfort situation, such that the predetermined values are continuously optimized.

FIG. 4 is a schematic representation of a complete control system of a plurality of comfort air vents in the form of a block diagram. Each air vent has assigned to it a sensor system, i.e. a number of sensors, such as temperature sensor, air speed sensor, humidity sensor, air quality sensor, and an actuator system, such as a motor to drive a fan, a cooling means (e.g. a Peltier element), a heating element (e.g. a PTC element), fragrancing means, humidifying/drying means, a motor for up/down flow direction adjustment, a motor for left/right flow direction adjustment and a motor for vent jet divergence (spot/diffuse). The measured values detected by the sensors are supplied via a sub-bus system, e.g. LIN (Local Interconnect Network), to the air-conditioning controller, which controls the air-conditioning function and adjusts the comfort air vents.

According to one variant, which is not illustrated in FIG. 4, direct actuation of the air vent actuators and direct detection of the air vent sensor system is provided instead of the sub-bus system.

Further measured values are supplied to the air-conditioning controller by other sensors, such as one or more surface temperature sensors (e.g. thermopile sensors), alertness sensors or out of position sensors. Added to these are data/measured values relating to set air-conditioning styles, the position of the window, of the sunroof and/or of the soft top, seat occupancy (empty, occupied, child seat) and body size (via the seat setting). Further conventional climate sensors supply further measured values. In addition, setpoint values may be changed manually by remote control means assigned to the individual seats or zones, or by direct input, for which purpose the appropriate data are likewise made available to the air-conditioning controller. This air-conditioning controller is additionally networked on the vehicle side, in the present case via CAN (Controller Area Network), whereby access is provided to the entire sensor system, which is not assigned directly to air-conditioning.

FIG. 5 shows system integration for the adjustment of comfort air vents. In this case, the external and internal temperature data detected by sensors, together with the setpoint values of the internal temperature, are supplied, separately for right and left, in standard manner to a main controller. This determines the main control variables Y_le and Y_ri, which are further processed together with other measured values from the solar sensor, humidity sensor, and set values such as the blower setpoint value, the seat position, the air-conditioning style and the manual air vent settings, and evaluated to yield the respective control variables for the individual air vents, namely the left-hand side vent (Y_SV_le), the left-hand central vent (Y_CV_le), the right-hand central vent (Y_CV_ri) and the right-hand side vent (Y_SV_ri), such that in each case the corresponding up/down, left/right, spot/diffuse servomotors are actuated (shown in FIG. 5 as state vectors).

FIG. 6 shows by way of example a function chart relating to “up/down” flow direction adjustment for the left-hand side vent as a function of the controller control variable Y_SV_le. In cooling operation (Y_SV_le<<0%) or in heating operation (Y_SV_le>>0%), automatic upwards adjustment of the air flow direction of the side vent is preferred, whereas in the neutral range (−10%≦Y_SV_le≦10%) the air jet tends to be adjusted downwards. Superimposed thereon is the detected basic setting of the “seat position” parameter, with automatic downward adjustment of the setting taking place if the seat position is moved backwards. Accordingly, automatic upward adjustment of the setting takes place if the seat position is moved forwards.

FIG. 7 shows by way of example a function chart relating to “left/right” flow direction adjustment for the left-hand side vent as a function of the controller control variable Y_SV_le. In cooling operation (Y_SV_le<<0%), it is advantageous for the air jet from the left-hand side vent to be automatically oriented towards the center of the vehicle, i.e. towards the driver, while in heating operation (Y_SV_le>>0%) adjustment in the direction of the side window is sensible, in particular to avoid misting up. Superimposed on the basic function are the parameters “humidity sensor” and “solar sensor”. The air jet is then directed towards the side window in cooling operation in the event of increased solar radiation. Corresponding orientation takes place in the range from gentle cooling operation to heating operation in the event of elevated humidity values, such that the side windows are automatically kept from misting up.

FIG. 8 is a function chart taking as an example the left-hand side vent and showing “spot/diffuse” adjustment as a function of the controller control variable Y_SV_le. In cooling operation (Y_SV_le<<0%), a “spot” setting is automatically preferred, while in the neutral range (−10%≦Y_SV_le≦10%) diffuse air jet divergence is preferred and in heating operation (Y_SV_le>>0%) an intermediate position. In the event of strong solar radiation, displacement preferably occurs towards the “spot” position. If there is any possibility of adjusting air-conditioning styles, the following characteristic curve shifts are sensible: if a “fresh” air-conditioning style is selected, a characteristic curve shift in the “spot” direction is sensible, whereas in the case of a “moderate” air-conditioning style a shift in the “diffuse” direction takes place.

A further parameter which is relevant to the adjustment of air jet divergence is the so-called alertness sensor. As alertness diminishes, detected for example by eyelid openness, an automatic adjustment in the “spot” direction and/or automatic temperature lowering occurs.

The function charts in FIGS. 6 to 8 take the left-hand side vent as an example. With appropriate adaptation, the functions may be applied to the right-hand side vent and to the two central vents.

### LIST OF REFERENCE NUMERALS

1 Control unit
2 Assembly
3 Central vent
3′ Central vent assigned to the driver
3″ Central vent assigned to the front passenger
4 Knob for setting the temperature setpoint value
5 Knob for setting blower output
6 Knob for setting air distribution
7 Switch for actuating/switching off the air-conditioning system
8 Switch for recirculation mode

1. A method for adjusting an air vent for air-conditioning a motor vehicle, the air vent having assigned to it an actuator for controlling a fan device and/or an actuator for controlling air jet divergence and/or an actuator for the air direction control means and/or a heating device, and at least one sensor being provided for recording measured values, wherein the settings of the air vent are adjusted as a function of measured values of the sensor.

2. The method as claimed in claim 1, wherein the automatic adjustment changes the setting of the air vent between spot jet and diffuse outflow.

3. The method as claimed in claim 1 wherein the automatic adjustment changes the directional setting of the air vent.

4. The method as claimed in claim 1, wherein the automatic adjustment changes the volume of air which enters the vehicle cabin through the air vent.

5. The method as claimed in claim 1, wherein the automatic adjustment changes the speed at which the air enters the vehicle cabin through the air vent.

6. The method as claimed in claim 1, wherein the automatic adjustment changes the mixing ratio of hot and cold air which enters the vehicle cabin through the air vent.

7. The method as claimed in claim 1, wherein the automatic adjustment changes the temperature of the air which enters the vehicle cabin through the air vent.

8. The method as claimed in claim 1, wherein the automatic adjustment changes the humidity of the air which enters the vehicle cabin through the air vent.

9. The method as claimed in claim 1, wherein the automatic adjustment changes a fragrance and/or the concentration thereof added to the air which enters the vehicle cabin through the air vent.

10. The method as claimed in claim 1, wherein the sensor detects the surface temperature of at least one body part of an occupant.

11. The method as claimed in claim 1, wherein the sensor detects seat occupancy and/or seat position and/or the posture and/or size of the occupant.

12. The method as claimed in claim 1, wherein the sensor detects solar radiation.

13. The method as claimed in claim 1, wherein the sensor detects the status of one or more windows and/or of a sunroof and/or of a soft top.

14. The method as claimed in claim 1, wherein the sensor detects humidity.

15. The method as claimed in claim 1, wherein the sensor detects zone-related measured values.

16. The method as claimed in claim 1, wherein manual readjustments are stored and taken into account when determining the optimum setting parameters for the air vent.

17. An air-conditioning or heating system having at least one air-conditioning controller and one or more air vents, the air vent having assigned to it a heating device and/or an air volume control means and/or an actuator for the air volume control means and/or a fan device and/or an actuator for controlling a fan device and/or an actuator for the air direction control means and/or an actuator for controlling air jet divergence, and at least one sensor being provided for recording measured values, wherein a program for automatically adjusting the air vent(s) as a function of measured values and setting values is assigned to the air-conditioning controller.

18. The air-conditioning or heating system as claimed in claim 17, wherein the program is adaptive.
